(19) United States
(12) Patent Application Publication
(10) Pub. No.: US 2006/0218208 A1
(43) Pub. Date: Sep. 28, 2006

(54) Computer system, storage server, search server, client device, and search method

(75) Inventors: Akihisa Nagami, Yokohama (JP); Shinji Kimura, Sagamihara (JP); Daisuke Yokota, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/145,255

(22) Filed: Jun. 3, 2005

(30) Foreign Application Priority Data
Mar. 25, 2005 (JP) 2005-088030

(51) Int. Cl. G06F 17/30

(52) U.S. Cl. 707/203

(57) ABSTRACT

A search system that can easily search documents while ensuring the security is provided. A computer system includes one or a plurality of client devices, a search server, and a storage server connected to each other via a communication channel, and conducts search in response to a search request from one client device. The storage server stores a disk image that allows the client device to perform a boot operation via a network, thereby providing data search service to the client device.

The present application is based on and claims priority of Japanese patent application No. 2005-88030 filed on Mar. 25, 2005, the entire contents of which are hereby incorporated by reference.

### BACKGROUND OF THE INVENTION

1. Field of the Invention

The present invention relates to a computer system, a storage server, a search server, a client device, and a search method, and more particularly, to a search system for use in a system in which a plurality of client devices can remotely perform a boot operation from a common storage system.

2. Description of the Related Art

In a typical known search system, a user accesses a host providing search services by using a personal computer (PC) and obtains a search result. In this type of search system, the path and the address of a file to be searched are registered in a directory search service. The user using the search services accesses this directory search service to search for the address of a desired document, and then obtains the address of the document. Thereafter, those who use this document can access the address to download the file. For this type of directory search service, the standardized technique disclosed in “UDDI Version 3.0.2” by Luc Clement and three others, [online], Oct. 19, 2004 [searched on Dec. 27, 2004], the Internet <URL:http://uddi.org/pubs/uddi-v3.0.2-20041019.htm> (Non-patent Document 1) is available.

In the above-described directory search system, a document to be searched has to be registered in a search server. Due to an increase in the capacity of storage media, such as hard disks, CD-ROMs, and DVD-ROMs, the number of documents and the amount of data has increased, and it has become difficult to register documents in the search server. When many users share a certain search server, the number or the type of documents that can be registered are limited in view of the security, and the users are unable to register all documents. Conversely, when many documents are registered in a search server, the use of the search server should be restricted to certain users.

### SUMMARY OF THE INVENTION

Accordingly, in view of this background, it is an object of the present invention to provide a search system that allows users to easily search for documents while ensuring the security.

According to one aspect of the present invention, there is provided a computer system including: a plurality of client devices that create and use documents, and also issue a search request and display information obtained in response to the search request; a search server that conducts search in response to the search request and sends a reply to the client device in response to the search request; an authentication server that returns user attribute information by using user information concerning the user of the client device as the key; and a storage server that provides a disk image allowing the client device to perform a boot operation via a network.

The client device has the function of performing a boot operation from a disk image containing OS information stored in the storage server rather than from a storage unit directly connected to the client device.

The search server has the following functions: mounting/unmounting the disk image stored in the storage server and used by the client device; forming a search index for the files stored in the disk image; forming the search index upon receiving a message indicating that unmounting has been conducted from the storage server; converting the format of a cache file; and receiving a search request from the client device via a user interface which provides a search service to the client device, sending user information concerning the user of the client device that has sent the search request to the authentication server, restricting a search range based on a reply from the authentication server, and sending a reply in response to the search request.

The authentication server has user attribute information concerning the user section, the user job grade, and a password, and has the function of returning the user attribute information in response to a query based on the user information from the search server.

The storage server stores a disk image used for starting the client device, and has the function of conducting authentication in response to a mount request to mount the disk image from the client device or the search server. The storage server also has a protocol for allowing the client device to perform a boot operation via a network and has the functions of creating and updating a copy of the disk image, and informing that the mounting/unmounting of the disk image has been conducted.

That is, the present invention provides a computer system which includes one or a plurality of client devices, a search server, and a storage server connected to each other via a communication channel and which conducts search in response to a search request from one client device. The storage server stores a disk image that allows the client device to perform a boot operation via a network. With this configuration, the computer system provides a data search service to the client device.

The present invention offers the following advantages. According to a first advantage, the user can search for a file without registering that file in a search server. According to a second advantage, a user can search for a file formed by another user. In this case, instead of allowing the user to search for all files, certain restrictions are imposed such that only files concerned with the section to which the user belongs can be searched, or files formed by another user having a job grade higher than that of the user cannot be searched. Accordingly, the security can be ensured. According to a third advantage, a search index can be formed even when the client device is not powered on. According to a fourth advantage, a search result that can be viewed through various OSs and platforms can be returned.

### BRIEF DESCRIPTION OF THE DRAWINGS

FIG. 1 is a block diagram illustrating the configuration of a computer system according to a first embodiment of the present invention;

FIG. 2 is a block diagram illustrating the hardware configuration of the computer system according to the first embodiment of the present invention;

FIG. 3 is a block diagram illustrating the configuration of a search server in the first embodiment of the present invention;

FIG. 4 is a block diagram illustrating the configuration of an authentication server in the first embodiment of the present invention;

FIG. 5 is a block diagram illustrating the configuration of a storage server in the first embodiment of the present invention;

FIG. 6 illustrates a volume connection management table in the search server in the first embodiment of the present invention;

FIG. 7 illustrates a search index in the search server in the first embodiment of the present invention;

FIG. 8 illustrates a user information table in the authentication server in the first embodiment of the present invention;

FIG. 9 illustrates a volume management table in the storage server in the first embodiment of the present invention;

FIG. 10 is a flowchart illustrating a process from when a file is formed by using a client device in the computer system of the first embodiment of the present invention to when the file is registered in the search index;

FIG. 11 is a flowchart illustrating a search sequence in the computer system in the first embodiment of the present invention;

FIG. 12 is a flowchart illustrating a process until a client device in a computer system in a second embodiment of the present invention logs in a blade server to start an operation;

FIG. 13 illustrates a search request sent from a client device to the search server in the first embodiment of the present invention;

FIG. 14 illustrates a search reply sent from the search server to the client device in the first embodiment of the present invention;

FIG. 15 illustrates an authentication request sent from the search server to the authentication server in the first embodiment of the present invention;

FIG. 16 illustrates an authentication reply sent from the authentication server to the search server in the first embodiment of the present invention;

FIG. 17 is a block diagram illustrating the configuration of the computer system according to the second embodiment of the present invention;

FIG. 18 is a block diagram illustrating the blade server in the second embodiment of the present invention;

FIG. 19 illustrates a mount request in the first embodiment of the present invention;

FIG. 20 illustrates a mount reply in the first embodiment of the present invention;

FIG. 21 illustrates an unmount request in the first embodiment of the present invention;

FIG. 22 illustrates an unmount reply in the first embodiment of the present invention; and

FIG. 23 illustrates an access restriction keyword table in the search server in the first embodiment of the present invention.

### DESCRIPTION OF THE PREFERRED EMBODIMENTS

A computer system, a storage server, a search server, a client device, and a search method according to preferred embodiment of the present invention are described below with reference to the accompanying drawings.

### First Embodiment

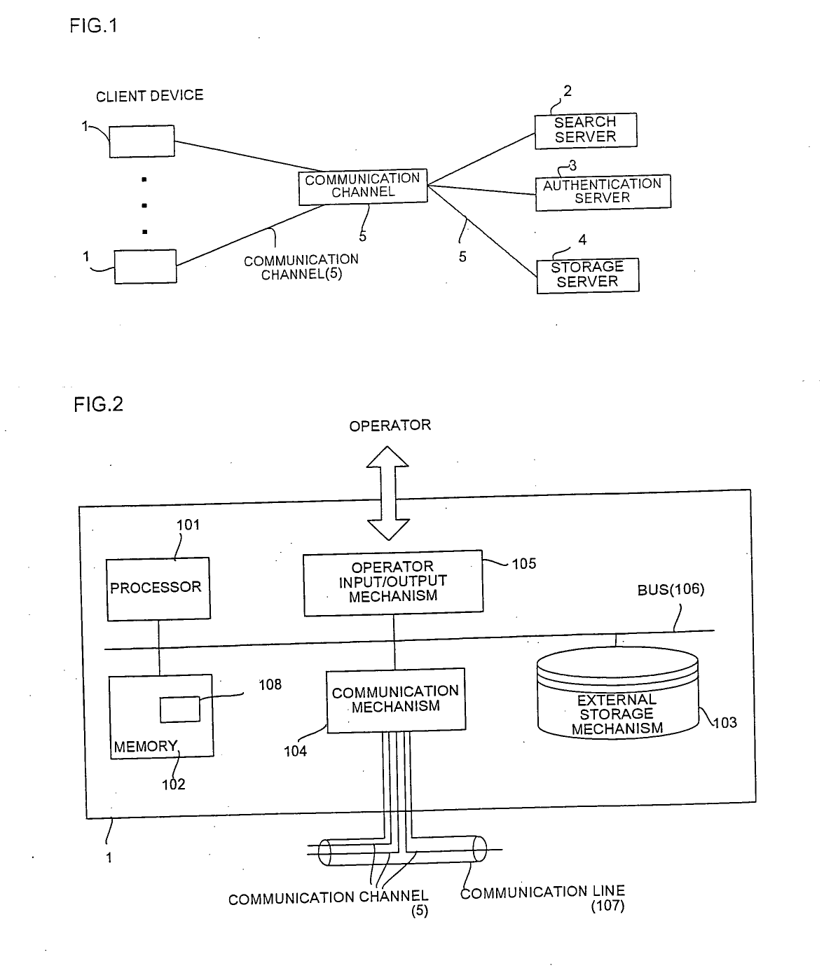

The principle configuration of a first embodiment of the present invention is described below with reference to the drawings. FIG. 1 is a system block diagram illustrating the first embodiment of the present invention using a processing method and a processing apparatus. One or a plurality of client devices 1, a search server 2, an authentication server 3, and a storage server 4 are connected to each other via a communication channel 5. The communication channel 5 is not necessarily a physical communication line, and may be a logical communication channel implemented on a physical communication line.

An example of the physical configuration of each of the client devices 1, the search server 2, the authentication server 3, and the storage server 4 is shown in FIG. 2. Those devices may be, as shown in FIG. 2, physically general information processing apparatuses. More specifically, each information processing apparatus includes a processor 101, a memory 102, an external storage mechanism 103, a communication mechanism 104, and an operator input/output mechanism 105 connected to each other via an internal communication line 106, such as a bus. The processor 101 executes an information processing program 108 stored in the memory 102. The memory 102 stores, not only the information processing program 108, but also various items of data referred to by the information processing program 108.

The external storage mechanism 103 stores the information processing program 108 and various items of data in a non-volatile manner. The information processing program 108 executed on the processor 101 instructs the external storage mechanism 103 to load required programs data to the memory 102, and conversely, to store required programs and data in the memory 102 in the external storage mechanism 103. The programs may be stored in the external storage mechanism 103 in advance. If necessary, the programs may be read from an external device via, for example, a portable storage medium or a communication medium. The client device 1 may be formed of a computer without a locally connected external storage mechanism, and such a client device is referred to as a “diskless client”.

The communication mechanism 104 is connected to a communication line 107, and in response to an instruction of the information processing program 108, the communication mechanism 104 sends data to another information processing apparatus or communication device, or receives data from another information processing apparatus or communication device and stores the data in the memory 102. The logical communication channel 5 for connecting the individual elements can be implemented via the communication mechanism 104 through the physical communication line 107. The operator input/output mechanism 105 performs data input/output with an operator. The internal communication line 106, which is formed of, for example, a bus, implements communication between the processor 101, the memory 102, the external storage mechanism 103, the communication mechanism 104, and the operator input/output mechanism 105.

It is not necessary that the client devices 1, the search server 2, the authentication server 3, and the storage server 4 be different in the physical configuration. The difference of the functions of the individual elements may be implemented by the information processing program 108 executed on the individual devices.

In the following description, the elements in the embodiments are referred to as “processing units”, and each processing unit is a logical configuration, and may be a physical mechanism or one function implemented by the information processing program 108. It is not necessary that the client devices 1, the search server 2, the authentication server 3, and the storage server 4 be independent physical devices, and instead, a single device may simultaneously implement the functions of a plurality of devices selected from the client devices 1, the search server 2, the authentication server 3, and the storage server 4.

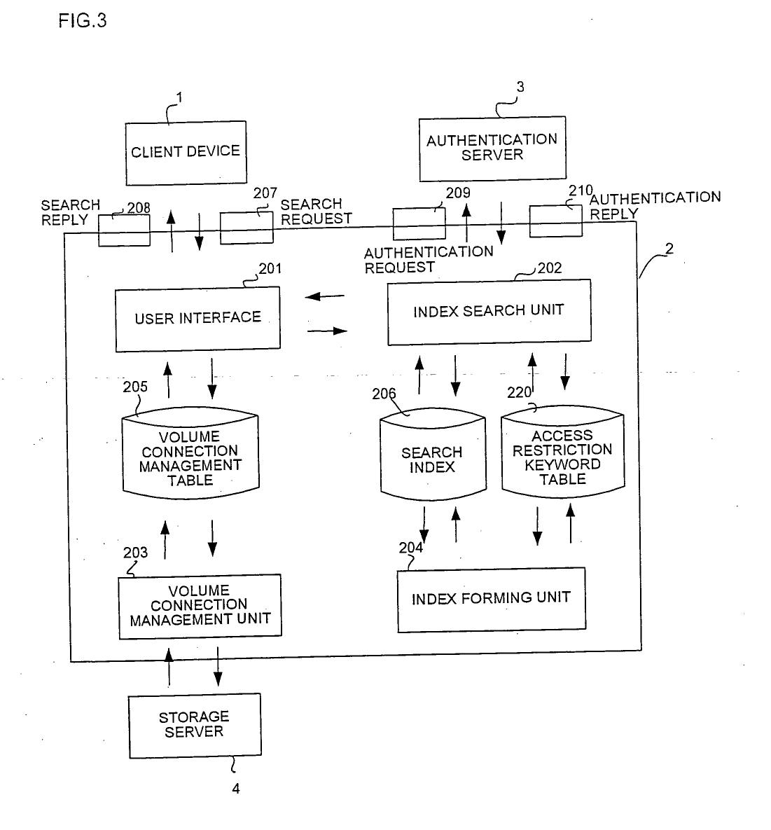

FIG. 3 illustrates an example of the configuration of the search server 2. In this embodiment, the search server 2 includes a user interface 201, an index search unit 202, a volume connection management unit 203, an index forming unit 204, a volume connection management table 205, a search index 206, and an access restriction keyword table 220.

The user interface 201 provides a search interface for the client device 1. The user interface 201 receives a search request 207 from the client device 1, forms a search reply 208 from a search result in response to the search request 207, and sends the search reply 208 to the client device 1.

The index search unit 202 is a processing unit for conducting search from the search index 206. In this case, the index search unit 202 changes a search range in cooperation with the authentication server 3. The index search unit 202 sends an authentication request 209 to the authentication server 3, selects an entry used for search from the search index 206 based on an authentication reply 210 in response to the authentication request 209, and then conducts search. In this case, the index search unit 202 refers to the access restriction keyword table 220 to perform access restriction based on access restriction keywords contained in a document.

The volume connection management unit 203 receives information concerning the mounting/unmounting of a volume from the storage server 4. Alternatively, the volume connection management unit 203 may ask the storage server 4 at regular intervals whether a volume is mounted or unmounted. Then, the volume connection management unit 203 reflects the state of a volume in the volume connection management table 205. The index forming unit 204 updates the search index 206 when a volume is unmounted based on the detection by the volume management unit 203.

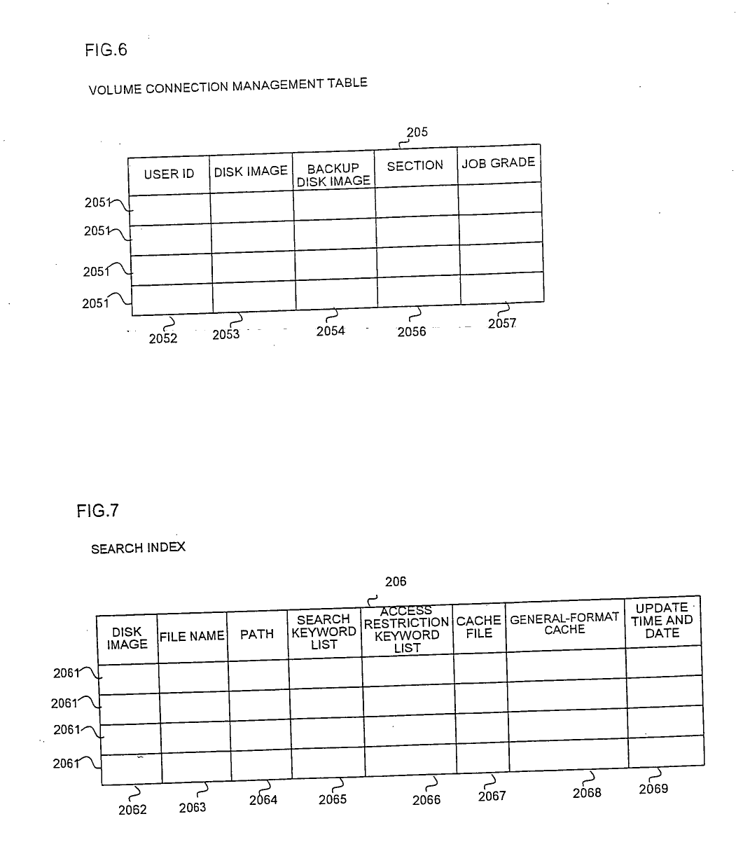

FIG. 6 illustrates an example of the configuration of the volume connection management table 205 in the search server 2. By using a user ID 2052 as the key, a volume connection management entry 2051 is stored in the fields of a disk image 2053, a backup disk image 2054, a section 2056, a job grade 2057, and the user ID 2052.

FIG. 7 illustrates an example of the configuration of the search index 206 in the search server 2. For each disk image 2062, a search keyword list 2065, an access restriction keyword list 2066, a cache file 2067, a general-format cache 2068, and an updated time and date 2069 are stored in association with a file name 2063 and a path 2064 corresponding to the file name 2063.

FIG. 23 illustrates an example of the configuration of the access restriction keyword table 220 in the search server 2. For each access restriction keyword entry 2201, a keyword 2202 and a searchable range 2203 are stored.

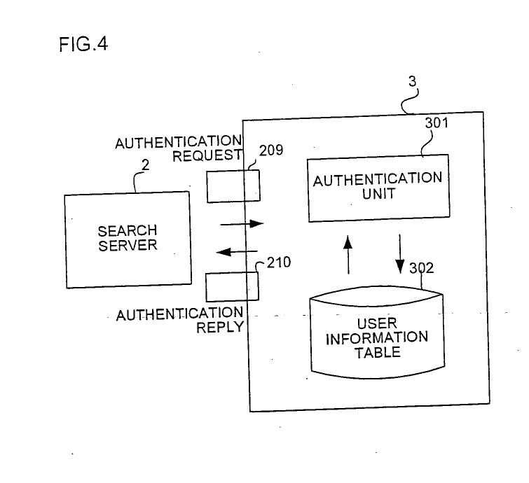

FIG. 4 illustrates an example of the configuration of the authentication server 3. The authentication server 3 includes an authentication unit 301 and a user information table 302. Upon receiving the authentication request 209 from the search server 2, the authentication unit 301 searches the user information table 302 by using a user ID 2091 (FIG. 15) as the key and sends the authentication reply 210 to the search server 2.

FIG. 8 illustrates an example of the configuration of the user information table 302 in the authentication server 3. The user information table 302 has information concerning a password 3023, a section 3024, a job grade 3025 based on a user ID 3022 as the key, and a user information entry 3021 is stored for each user ID 3022.

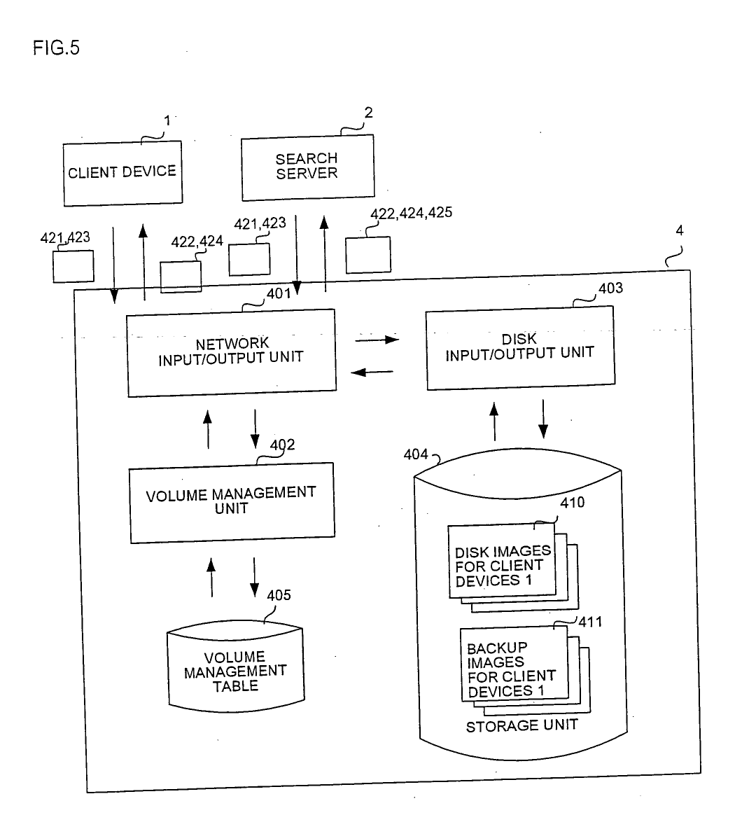

FIG. 5 illustrates an example of the configuration of the storage server 4. The storage server 4 includes a network input/output unit 401, a volume management unit 402, a disk input/output unit 403, a storage unit 404, and a volume management table 405.

The network input/output unit 401 receives a request to perform mounting/unmounting, to read data from a disk, or to write data into a disk from the client device 1 or the search server 2. When receiving a request to perform mounting/unmounting, the network input/output unit 401 performs mounting/unmounting in cooperation with the volume management unit 402. When receiving a request to read or write data from or into a disk, the network input/output unit 401 reads or writes data from or into the disk in cooperation with the disk input/output unit 403.

The volume management unit 402 manages the state of mounting/unmounting of disk images 410 stored in the storage unit 404 for the client device 1. Management information is stored in the volume management table 405.

The disk input/output unit 403 inputs or outputs data into or from a disk, and stores data in the storage unit 404 in response to a read or write request.

The storage unit 404 stores the disk images 410 used by the client device 1 and backup images 411 for the disk images 410. The storage unit 404 may be formed of, for example, redundant array of inexpensive disks (RAID).

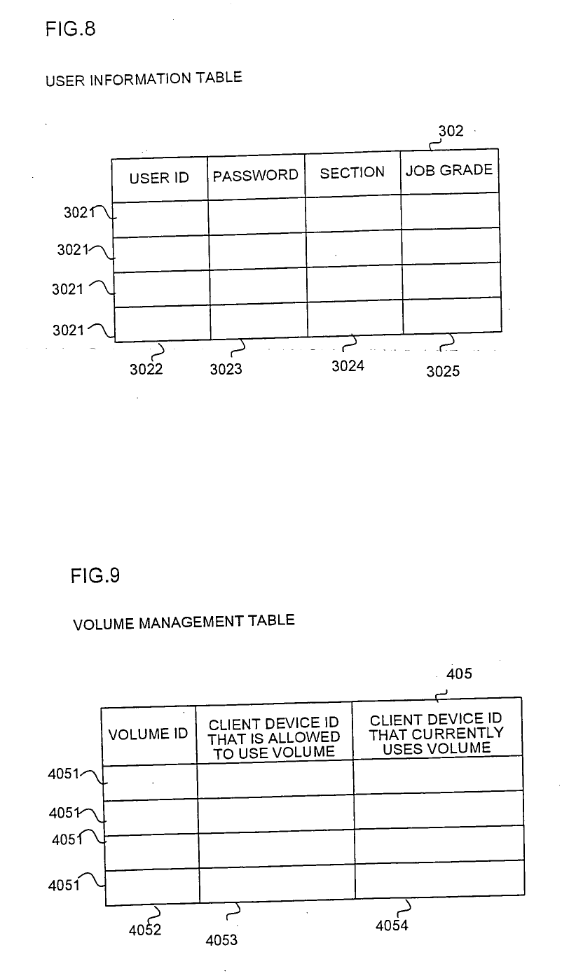

FIG. 9 illustrates an example of the configuration of the volume management table 405 in the storage server 4. The volume management table 405 has the fields of a client device ID 4053 that is allowed to use a corresponding volume and a client device ID 4054 that currently uses the corresponding volume based on a volume ID 4052 as the key. A volume management entry 4051 is stored for each volume ID 4052.

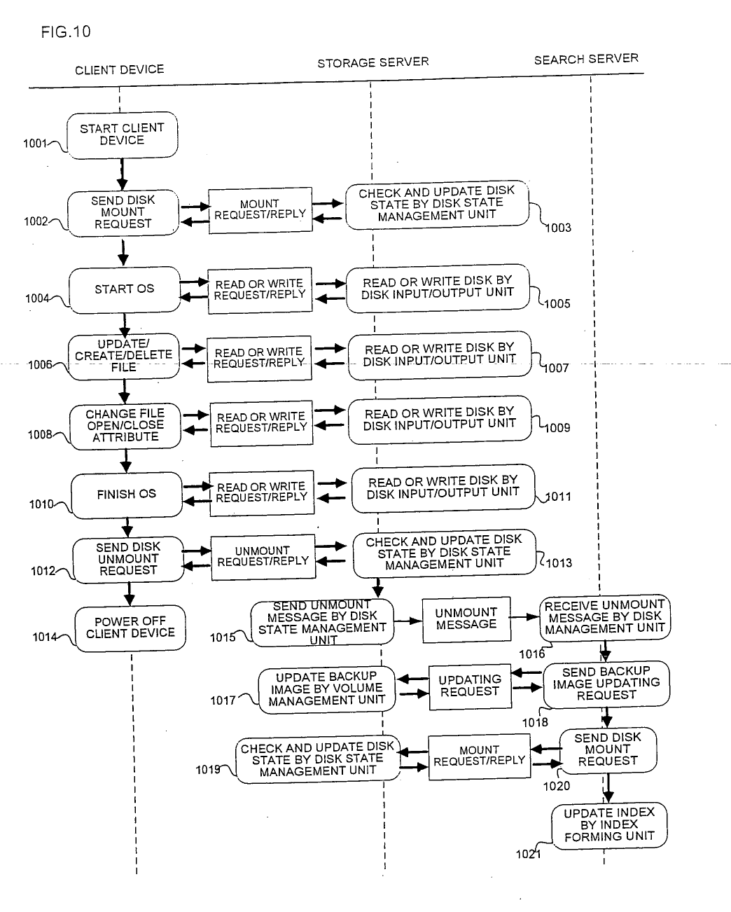

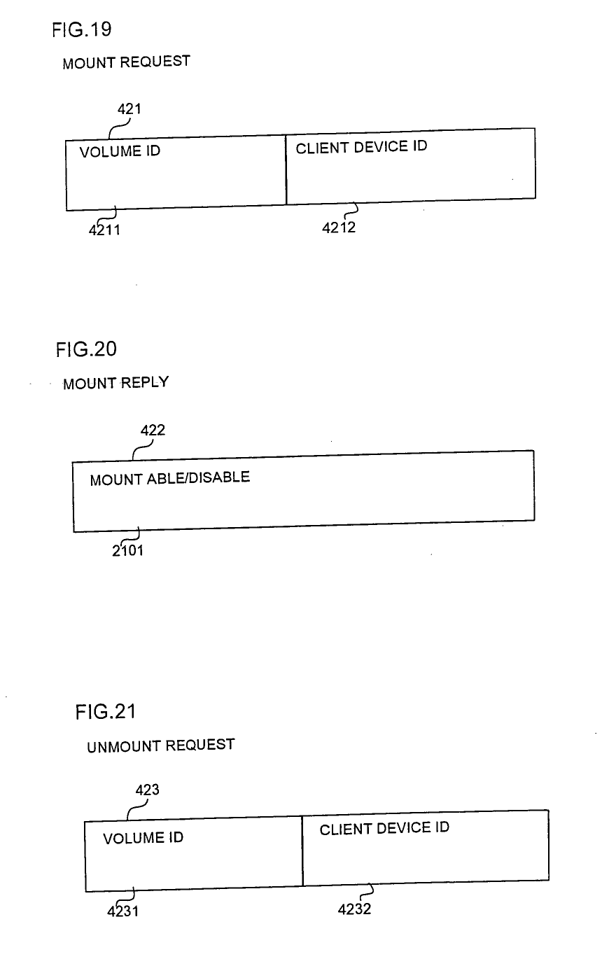

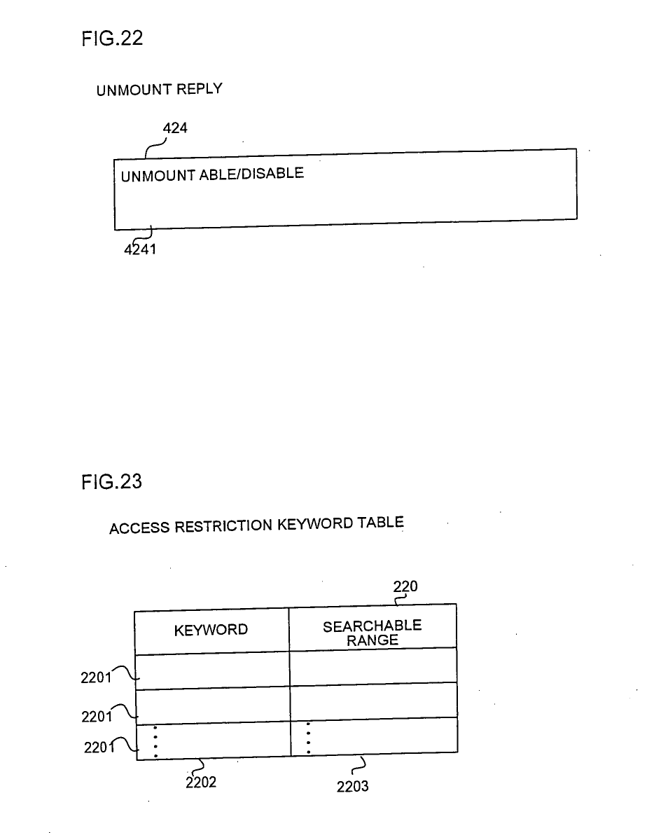

A description is now given, with reference to FIGS. 10 and 11, of the operation of the client device 1, the search server 2, the authentication server 3, and the storage server 4 according to the first embodiment. FIG. 10 is a flowchart illustrating a process for registering a document to be searched in the search index 206. In step 1001, the client device 1 is started. In step 1002, to start an OS, the client device 1 sends a mount request 421 (FIG. 19) to mount the disk image 410 storing information concerning the OS. Upon receiving the mount request 421, in step 1003, the storage server 4 checks and updates the volume management table 405, and replies to the client device 1.

The above-described updating processing may be implemented by the following procedure. The volume management entry 4051 in the volume management table 405 having the volume ID 4052 that is the same as a volume ID 4211 of the mount request 421 is searched. Then, the client device ID 4053 that can use the corresponding volume is compared with a client device ID 4212 indicated in the mount request 421. If the two IDs coincide with each other, the value of the client device ID 4054 that currently uses the corresponding volume is checked to determine whether it is zero. If the value is not zero, the volume designated in the mount request 421 is being used, and a mount disable reply is returned. If the value of the client device 4054 is zero, the client device ID 4212 in the mount request 421 is stored in the client device 4054, and the updating of the volume management table 405 is completed.

In step 1004, the client device 1 reads the mounted disk image 410 and writes it therein to start the OS. Then, in step 1006, the user can create, delete, or update a corresponding file by using the client device 1.

In response to the operation in step 1006, in step 1007, a read or write request is sent to the storage server 4, and the disk input/output unit 403 of the storage server 4 reads or writes the disk image 410 from or into the storage unit 404, and returns the result to the client device 1.

Thereafter, a read or write request is sent in step 1007 in response to the operation performed in step 1006 until the client device 1 finishes the operation.

In step 1008, the user of the client device 1 determines whether the file created in step 1006 is registered in the search server 2, and changes the file open/close attribute. In this step, by using the function of access restriction on owners/groups/users, which is a general function of the OS, an access right for the users accessing the search server 2 may be set.

After the operation, in step 1010, the user finishes the OS. Then, in step 1012, the client device 1 sends an unmount request 423 (FIG. 21) for the disk image 410 before the client device 1 is shut down. In response to the unmount request 423, in step 1013, the storage server 4 updates the volume management table 405 and responds to the client device 1.

The above-described updating processing may be implemented by the following procedure. The volume management entry 4051 in the volume management table 405 having the volume ID 4052 that is the same as an volume ID 4231 of the unmount request 423 is searched. Then, the client device ID 4054 that is using the corresponding volume of the volume management entry 4051 is compared with a client device ID 4232 specified in the unmount request 423. If the two IDs are equal to each other, the value of the client device ID 4054 is set to be zero, and a message indicating that unmounting has been successfully finished is returned. If the two IDs are not the same, the volume specified in the unmount request 423 is being used by another client device, and then, an unmount disable reply is returned. The updating processing of the volume management table 405 is then completed. In step 1014, the client device 1 is shut down.

In step 1015, upon receiving the unmount request 423 from the client device 1, the storage server 4 performs unmounting, and then sends an unmount message 425 to the search server 2.

In step 1016, upon receiving the unmount message 425, the search server 2 performs subsequent processing for forming the search index 206. In this embodiment, the storage server 4 sends the unmount message 425 to the search server 2. However, the search server 2 may ask the storage server 4 about the mounting state of disks at regular intervals, and upon detecting that the mounting state has been shifted to the unmounting state, the search server 2 may start the following processing.

In step 1018, the search server 2 sends the storage server 4 an updating request to update the disk image 410 that has been used and the associated backup disk image 411. In this case, the same value as the volume ID 4251 contained in the unmount message 425 is searched for from the volume connection management table 205.

If the volume connection management entry 2051 having the disk image 2053 which is the same as the volume ID 4251 is found, the updating request is sent, together with the backup disk image 2054 of the volume connection management entry 2051, to the storage server 4.

In step 1017, the storage server 4 updates the backup image 411.

Then, in step 1020, the search server 2 sends a mount request to mount the backup image 411.

In step 1019, the storage server 4 updates the disk state in response to the mount request. Step 1019 can be executed in a manner similar to step 1003.

In step 1021, the search server 2 updates the search index 206 based on the mounted backup image 411.

The search index 206 conducts lexical analysis of the content and the name of a file stored in the search index 206 for each file image, and stores the keyword in the search keyword list 2065.

In the disk image 2062 in the search index 206, the backup disk image 2054 of the volume connection management entry 2051 having the same ID as the volume ID 4251 contained in the unmount message 425 is stored. The path 2064 and the updated time and date 2069 are obtained from the file system.

In the cache file 2067 in the search index 206, the file itself is stored. In the general-format cache 2068, the file generated by converting the cache file into a general format, for example, Hyper Text Markup Language (HTML), is stored.

In the access restriction keyword list 2066 in the search index 206, the character strings contained in the file and the keywords contained in the access restriction keyword table 220 in the search server 2 are stored.

In this case, files that are determined not to be opened or not to be accessed from the search server 2 in step 1008 are not stored in the search index 206.

A process for responding to a search request from the client device 1 is described below with reference to the flowchart of FIG. 11.

In step 1101, the user of the client device 1 starts searching for a document by using the client device 1.

In step 1102, the client device 1 obtains a search page, which serves as an interface for a search request, from the search server 2.

In step 1103, the search server 2 sends a reply in response to a request to send the search page from the client device 1.

In step 1104, the client device 1 sends the search request 207 containing a search keyword input by the user to the search server 2.

In step 1105, the search server 2 receives the search request 207 from the client device 1.

In step 1106, the search server 2 stores a user ID 2072 and a password 2073 contained in the search request 207 received from the client device 1 as a user ID 2091 and a password 2092 in the authentication request 209, and sends the authentication request 209 to the authentication server 3.

In step 1107, the authentication server 3 receives the authentication request 209 from the search server 2.

In step 1108, the authentication unit 301 of the authentication server 3 refers to the user information table 302 by using the user ID 2091 contained in the authentication request 209 as the key. The authentication unit 301 searches for the user information entry 3021 in the user information table 302 having the user ID 3022 which coincides with the user ID 2091 contained in the authentication request 209.

In step 1109, the authentication server 3 sends an authentication reply 210 to the search server 2. The authentication unit 301 of the authentication server 3 sets an authentication permission/rejection 2101 (FIG. 16) in the authentication reply 210. As a result of conducting the above-described search, if the password 3023 of the user information entry 3021 having the same user ID 3022 as the user ID 2091 contained in the authentication request 209 coincides with the password 2092 contained in the authentication request 209, 0 is stored in the authentication permission/rejection 2101, and if the two passwords are different or if the user information entry 3021 having the user ID 3022 which is the same as the user ID 2091 cannot be found, −1 is stored in the authentication permission/rejection 2101.

In a user job grade 2102 and a user section 2103 in the authentication reply 210 (FIG. 16), the job grade 3025 and the section 3024 in the user information table 302 are stored.

In step 1110, the index search unit 202 in the search server 2 receives the authentication reply 210 from the authentication server 3. If the value of the authentication permission/rejection 2101 is −1, the index search unit 202 returns an error to the client device 1 via the user interface 201.

In step 1111, the index search unit 202 in the search server 2 refines a search range from the search index 206.

In this case, the index search unit 202 determines whether each search index entry 2061 in the search index 206 can be a search target. More specifically, the index search unit 202 compares the section 2056 and the job grade 2057 of the volume connection management entry 2051 having the disk image 2053 which is the same as the disk image 2062 are compared with the user section 2103 and the user job grade 2102 in the authentication reply 210.

If the user section 2103 is different from the section 2056 or it is not contained in the volume connection management table 205, the corresponding search index entry 2061 is excluded from the search targets. If the user job grade 2102 is lower than the job grade 2057, the corresponding search index entry 2061 is excluded from the search targets. Additionally, the index search unit 202 refers to the access restriction keyword list 2065, and if a keyword is contained in the list 2065, the index search unit 202 searches the access restriction keyword table 220 for the access restriction keyword entry 2201 having the keyword 2202 which is the same as the keyword in the access restriction keyword list 2065, and refers to the searchable range 2203 corresponding to the keyword 2202. If the user section 2103 coincides with or is contained in the searchable range 2203, the corresponding search index entry 2061 is excluded from the search targets. As a result of performing the above-described processing, the remaining search index entries 2061 are set to be the search targets.

In step 1112, the index search unit 202 in the search server 2 conducts search from the refined search index 206.

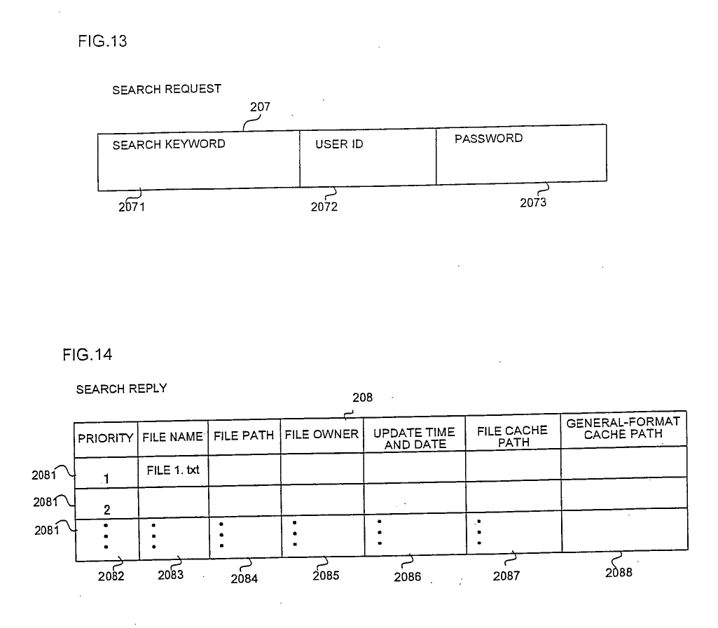

The index search unit 202 searches for the search index entry 2061 having the search keyword list 2065 which is the same as a search keyword 2071 (FIG. 13) in the search request 207.

In step 1113, the search server 2 sends the search reply 208 to the client device 1. In the search reply 208, a priority 2082 is assigned in the order of the search keyword lists 2065 containing the search keyword 2071 in the search request 207. The file name 2063 in the search index 206 is stored in a file name 2083 in the search reply 208, and the path 2064 in the search index 206 is stored in a path 2084 in the search reply 208. In a file owner 2085 in the search reply 208, the user ID 2052 of the volume connection management entry 2051 of the volume connection management table 205 having the disk image 2053 that is the same as the disk image 2062 of the search index 206 is stored.

In an updated time and date 2086, a file cache path 2087, and a general-format cache path 2088 in the search reply 208, the updated time and date 2069, the cache file path 2064, and the general-format cache 2068 in the search index 206 are respectively stored.

In step 1114, the client device 1 displays the search reply 208 received from the search server 2.

According to the above-described processing, files created or updated in the client device 1 can be searched. Even when the client device 1 is not powered on, the disk images 410 are stored in the storage server 4, thereby making it possible to form the search index 206 or conduct search.

### Second Embodiment

It may be difficult for a client device to download an OS image from a storage server via a network since the network bandwidth used by the client device is not sufficient. To deal with such a situation, in a second embodiment of the present invention, the amount of communication performed in a client device via a network is reduced.

The second embodiment is effective when a client device does not have a function of booting an OS via a network or when the client device is unable to directly communicate with a storage server due to the restriction of the network configuration.

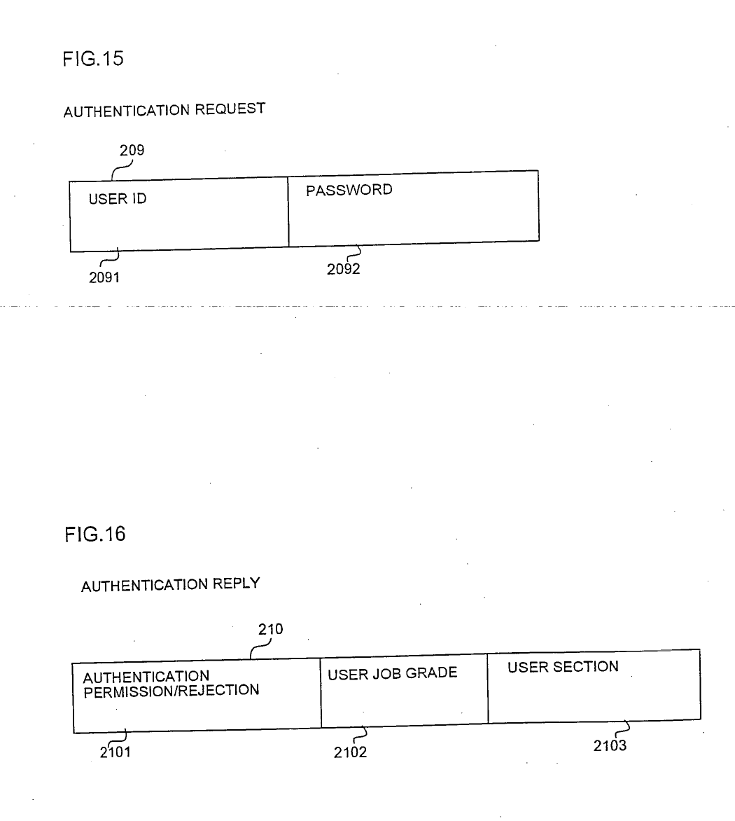

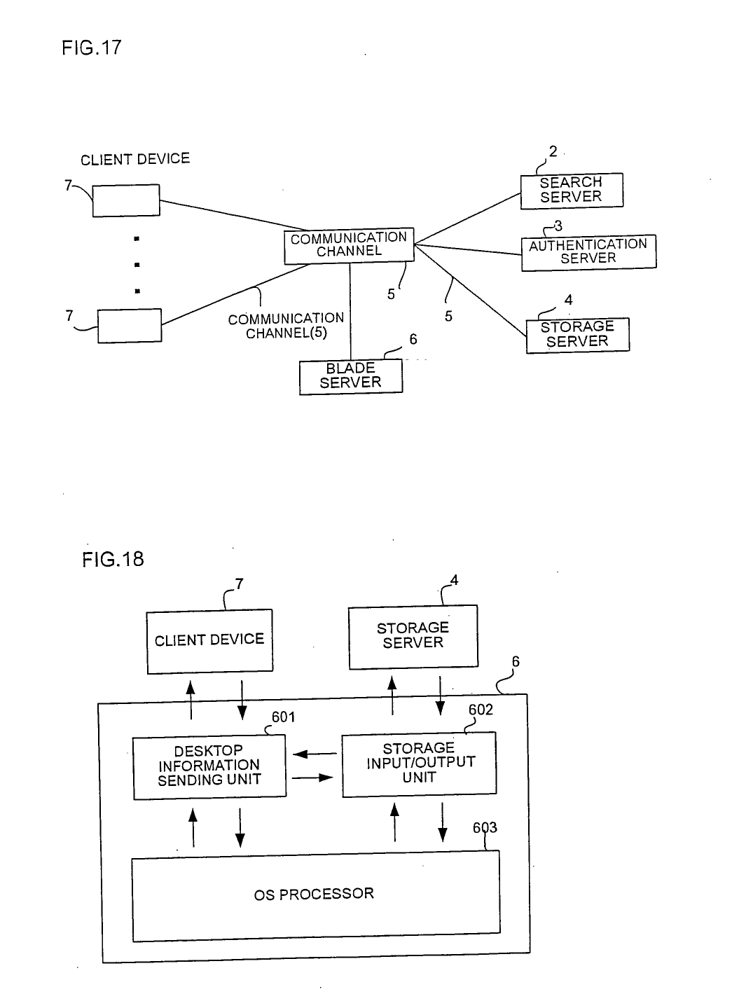

FIG. 17 is a system block diagram illustrating the second embodiment of the present invention. One or a plurality of client devices 7, the search server 2, the authentication server 3, the storage server 4, and a blade server 6 are connected to each other via the communication channel 5.

Each of the client devices 7, the search server 2, the authentication server 3, the storage server 4, and the blade server 6 may be physically configured as shown in FIG. 2. However, the blade server 6 may be a diskless client without an external storage mechanism.

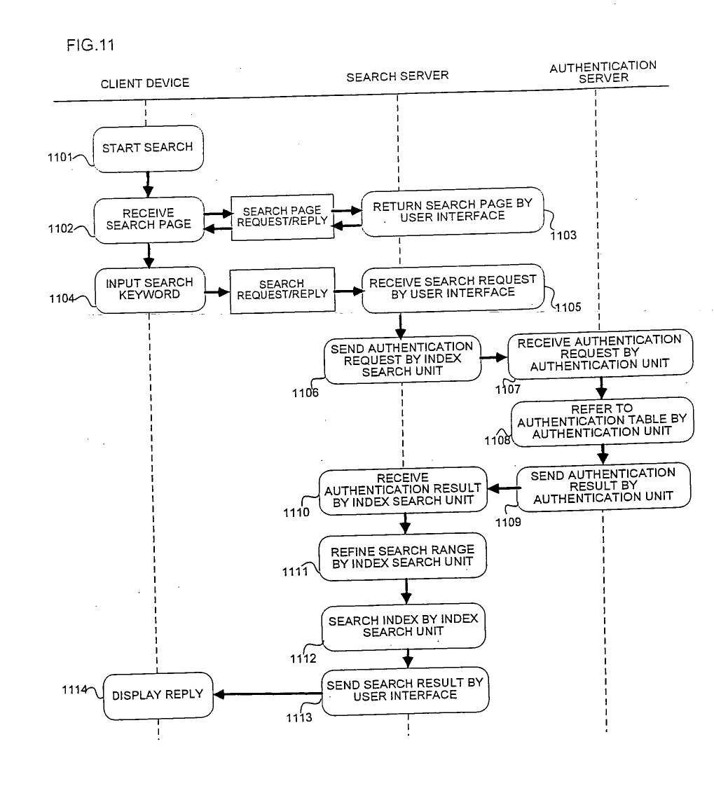

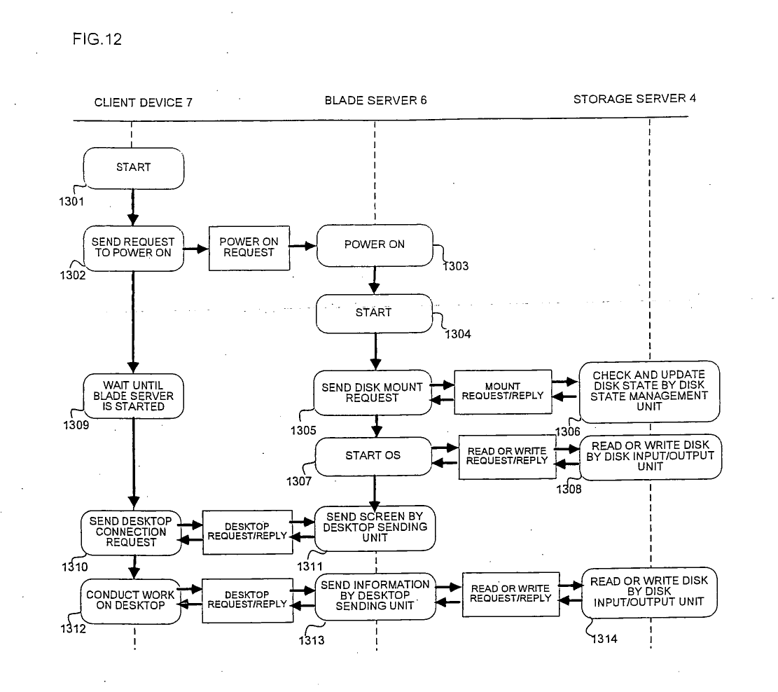

In this embodiment, the process until a user uses the client device 7 is described below with reference to the flowchart of FIG. 12.

In step 1301, the client device 7 is started. Then, in step 1302, the client device 7 requests the blade server 6 to power on the blade server 6.

In step 1303, the blade server 6 receives the request and is powered on. The power control in steps 1301 and 1303 may be implemented by using the technique of Wake-On-LAN.

In step 1304, the blade server 6 is started by using a disk stored in the storage server 4. Steps 1304 through 1308 correspond to steps 1001 through 1005 in FIG. 10 performed by the client device 1 in the first embodiment.

In step 1309, the client device 7 waits during steps 1303 through 1308 until the blade server 6 is started.

After the blade server 6 is started, in step 1310, the client device 7 receives a desktop screen from the blade server 6 and sends a desktop connection request to the blade server 6 to conduct work on the blade server 6.

In step 1311, the blade server 6 sends the desktop screen to the client device 7 in response to the desktop connection request.

In step 1312, the client device 7 conducts work on the desktop screen, and if necessary, in step 1313, the blade server 6 sends desktop information to the client server 7.

If it is necessary that a disk is read or written during the work conducted by the client device 7, in step 1314, the blade server 6 sends a read or write request to the storage server 4, and receives data and processes it.

According to the above-described processing, the client device 7 can obtain desktop information via the blade server 6 without directly communicating with the storage server 4, thereby conducting work by using a disk image stored in the storage server 4.

Since the blade server 6 is in the idle state while it is not being used by the client device 7, it may form the search index 206, which is performed by the search server 2 in step 1021 of FIG. 10 in the first embodiment. The number of disk images for which the search index entries 2061 in the search index 206 are formed is increased as the number of client devices 7 is increased. Additionally, the number of blade servers 6 is also increased as the number of client devices 7 is increased, and thus, the blade servers 6 in the idle state can be used so that the efficient formation of the search index entries 2061 in the search index 206 can be achieved.

The present invention can be used as a search system for a storage device, such as an IP storage device, that can be used by a plurality of devices via a network.

The present invention has been described through the first and second embodiments. However, various modifications may be made to the present invention as follows.

According to a first modified example of the present invention, in a computer system, the search server forms search index data from document data stored in the storage server, and verifies a search target against the search index data when conducting search.

According to a second modified example of the present invention, the computer system further includes an authentication server that performs user authentication, and the search server conducts search by restricting a search range based on user information obtained from the authentication server.

According to a third modified example of the present invention, in the computer system, a blade server that provides a desktop to the client device is connected via the communication channel to the client device that is able to receive desktop information from the blade server, and the blade server is started by using the disk image stored in the storage server and provides the desktop information to the client device.

According to a fourth modified example of the present invention, in the computer system, the storage server includes a network input/output unit, a disk input/output unit, a volume management unit that manages the disk image, a volume management table, and a storage unit that stores the disk image used by the client device. The search server includes a user interface for the client device, an index search unit, a volume connection management unit, an index forming unit that forms a search index from the disk image stored in the storage server.

According to a fifth modified example of the present invention, there is provided a storage server forming, together with at least one client device and a search server, a computer system that provides a data search service to the client device, and the storage server stores a disk image that allows the client device to perform a boot operation via a network.

According to a sixth modified example of the present invention, in the storage server, upon receiving a mount/unmount request from the search server, the disk mount state of the disk image is stored.

According to a seventh modified example of the present invention, in the storage server, wherein a message indicating unmounting is conducted is sent to the search server.

According to an eighth modified example of the present invention, in the storage server, a document that is being formed by the client device is copied and a copied document is also usable.

According to a ninth modified example of the present invention, the storage server includes a copy of an area in which data to be provided to the client device is stored, and, when the client device finishes using the area, the area used by the client device is updated in synchronization with the copy of the area.

According to a tenth modified example of the present invention, there is provided a search server forming, together with at least one client device and a storage server, a computer system that provides a data search service to the client device. The search server obtains data from a disk image stored in the storage server via a communication channel to form a search index.

According to an eleventh modified example of the present invention, in the search server, the search index is formed from a copy area.

According to a twelfth modified example of the present invention, in the search server, the search index is formed by conducting search via a network and by mounting a disk.

According to a thirteenth modified example of the present invention, in the search server, a file to be searched is stored in the search index as a cache file.

According to a fourteenth modified example of the present invention, in the search server, a file format of the cache file is converted into a general format, and the general-format cache file is stored.

According to a fifteenth modified example of the present invention, the search server conducts search by restricting a range to be searched based on user information obtained from an authentication server to generate a search result.

According to a sixteenth modified example of the present invention, in the search server, the user that is allowed to conduct search is changed according to character strings contained in the file.

According to a seventeenth modified example of the present invention, there is provided a client device connected to a computer system including at least one client device, a search server, a boot server, and a storage server and providing a data search service. The client device, which is not provided with a locally connected external storage mechanism, performs a boot operation via a network to obtain an area in which data is stored from the storage server.

According to an eighteenth modified example of the present invention, there is provided a blade server that updates the search index for a client device which is connected to a computer system including at least one client device, a search server, and a storage server and providing a data search service.

According to a nineteenth modified example of the present invention, there is provided a search method for conducting search in response to one client device in a computer system including at least one client device, a search server, and a storage server connected to each other via a communication channel, the storage server storing a disk image that allows the client device to perform a boot operation via a network. The search method includes: forming search index data from document data stored in the storage server; and verifying a search target against the search index data when conducting search.

What is claimed is:

1. A computer system comprising:
at least one client device;
a search server; and
a storage server,
wherein the at least one client device, the search server, and the storage server are connected to each other via a communication channel so that search is conducted in response to a search request from one client device, and
the storage server stores a disk image that allows the client device to perform a boot operation via a network, thereby providing a data search service to the client device.

2. The computer system according to claim 1, wherein the search server forms search index data from document data stored in the storage server, and verifies a search target against the search index data when conducting search.

3. The computer system according to claim 1, further comprising an authentication server that performs user authentication, wherein the search server conducts search by restricting a search range based on user information obtained from the authentication server.

4. The computer system according to claim 1, wherein a blade server that provides a desktop to the client device is connected via the communication channel to the client device that is able to receive desktop information from the blade server, and
the blade server is started by using the disk image stored in the storage server and provides the desktop information to the client device.

5. The computer system according to claim 1, wherein the storage server includes a network input/output unit, a disk input/output unit, a volume management unit that manages the disk image, a volume management table, and a storage unit that stores the disk image used by the client device, and
the search server includes a user interface for the client device, an index search unit, a volume connection management unit, an index forming unit that forms a search index from the disk image stored in the storage server.

6. A storage server forming, together with at least one client device and a search server, a computer system that provides a data search service to the at least one client device,
wherein the storage server stores a disk image that allows the at least one client device to perform a boot operation via a network.

7. The storage server according to claim 6, wherein, upon receiving a mount/unmount request from the search server, a disk mount state of the disk image is stored.

8. The storage server according to claim 6, wherein a message indicating unmounting is conducted is sent to the search server.

9. The storage server according to claim 6, wherein a document that is being formed by the client device is copied and a copied document is also usable.

10. The storage server according to claim 6, wherein the storage server includes a copy of an area in which data to be provided to the client device is stored, and, when the client device finishes using the area, the area used by the client device is updated in synchronization with the copy of the area.

11. A search server forming, together with at least one client device and a storage server, a computer system that provides a data search service to the at least one client device,
wherein the search server obtains data from a disk image stored in the storage server via a communication channel to form a search index.

12. The search server according to claim 11, wherein the search index is formed from a copy area.

13. The search server according to claim 11, wherein the search index is formed by conducting search via a network and by mounting a disk.

14. The search server according to claim 11, wherein a file to be searched is stored in the search index as a cache file.

15. The search server according to claim 14, wherein a file format of the cache file is converted into a general format, and the general-format cache file is stored.

16. The search server according to claim 11, wherein the search server conducts search by restricting a range to be searched based on user information obtained from an authentication server to generate a search result.

17. The search server according to claim 16, wherein a user that is allowed to conduct search is changed according to character strings contained in the file.

18. A client device connected to a computer system comprising at least one client device, a search server, a boot server, and a storage server and providing a data search service,
wherein the client device, which is not provided with a locally connected external storage mechanism, performs a boot operation via a network to obtain an area in which data is stored from the storage server.

19. A search method for conducting search in response to one of at least one client device in a computer system comprising the at least one client device, a search server, and a storage server connected to each other via a communication channel, the storage server storing a disk image that allows the client device to perform a boot operation via a network, the search method comprising:
forming search index data from document data stored in the storage server; and
verifying a search target against the search index data when conducting search.
